(19) United States
(12) Patent Application Publication
(10) Pub. No.: US 2012/0063272 A1
(43) Pub. Date: Mar. 15, 2012

(54) CLOCK CONTROL SYSTEM

(76) Inventors: Alain Dorais, St-Hubert (CA); Mario Martin, Tres St-Redempteur (CA)

(21) Appl. No.: 13/046,911

(22) Filed: Mar. 14, 2011

Related U.S. Application Data
(60) Provisional application No. 61/313,978, filed on Mar. 15, 2010.

(51) Int. Cl. G04F 8/00

(52) U.S. Cl. 368/3; 368/9

(57) ABSTRACT

Embodiments of the invention provide, among other things, a control system for a game clock and a method of controlling a game clock or timer. The control system includes a stationary transmitter adapted to transmit an energizing signal and a portable signaling device having a transmitter for transmitting a clock signal when energized by the energizing signal. In some cases the transmitter is coupled to an actuator adapted to enable and disable transmission by the transmitter. The transmitter is adapted to transmit the clock signal when enabled by the actuator and energized by the first signal from the stationary transmitter. The control system can further include a stationary receiver that receives the clock signal and forwards it to a control circuit adapted to couple to and operate a game clock according to the clock signal.

### CROSS-REFERENCES

This application claims the benefit of U.S. Provisional Application No. 61/313,978, filed Mar. 15, 2010, the content of which is hereby incorporated by reference in its entirety.

### BACKGROUND

Many sporting events (e.g., hockey games, basketball games, football games, soccer matches, etc.) have a fixed duration that is often divided into two or more periods. A game timer or clock usually keeps track of how much time remains in the game or in a certain period. In many cases, the timer must be stopped and restarted at various points during the game. For example, the clock may be stopped when a player steps out of bounds, a foul is called, or a time-out is taken. An official blowing a whistle is often the cue to stop and/or start the game timer. A human clock operator, such as a sidelines official, operates the game clock in response to the official's whistle.

Human error in starting and stopping the game clock can have a significant negative impact on the sporting events themselves. For example, if an official blows a whistle with 2.0 seconds remaining on the clock, the human operator may inadvertently fail to stop the game clock until it reads 1.2 seconds, giving the trailing team less time and an unfair advantage to the winning team. In another example, a clock operator may forget to start the game clock immediately upon cue from the official, giving more time and an unfair advantage to the losing team. Given the potential adverse impact on the outcome of an event, it is desirable to increase the accuracy and response times for sporting event time-keeping.

### SUMMARY

Aspects of the invention include, among other things, a control system for controlling a game clock or timer and a method of controlling a game clock. According to one aspect of the invention, a control system is provided for controlling a game clock. The control system includes a stationary transmitter adapted to transmit a first signal and a portable signaling device for transmitting a clock signal. The portable signaling device has a transmitter (e.g., a passive transmitter) coupled to an actuator that can enable and disable transmission by the transmitter. For example, the transmitter can transmit the clock signal when enabled by the actuator and energized by the first signal from the stationary transmitter. The control system further includes a stationary receiver adapted to receive the clock signal and a control circuit coupled to the stationary receiver. The control circuit receives the clock signal and operates the game clock according to the clock signal. In some embodiments the portable signaling device is a whistle.

Another aspect of the invention is a method of remotely controlling a game clock. The method includes transmitting a signal from a stationary transmitter, receiving the signal with a portable signaling device having a transmitter (e.g., a passive transmitter), and actuating the portable signaling device to enable transmission by the transmitter. The transmitter transmits a clock signal, which is received by a stationary receiver. The method also includes controlling operation of a game clock according to the clock signal.

These and various other features and advantages will be apparent from a reading of the following detailed description.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 is a block diagram of a clock control system according to an embodiment of the invention.

FIG. 2A is a side view of a portable signaling device according to an embodiment of the invention.

FIG. 2B is a top view of the portable signaling device of FIG. 2A.

FIG. 3 is a schematic representation of a transmitter and receiver arrangement according to an embodiment of the invention.

FIG. 4 is a schematic representation of a transmitter and receiver arrangement according to an embodiment of the invention.

FIG. 5 is a schematic representation of a transmitter and receiver arrangement according to an embodiment of the invention.

FIG. 6 is a flow diagram illustrating a method of controlling a game timer according to an embodiment of the invention.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

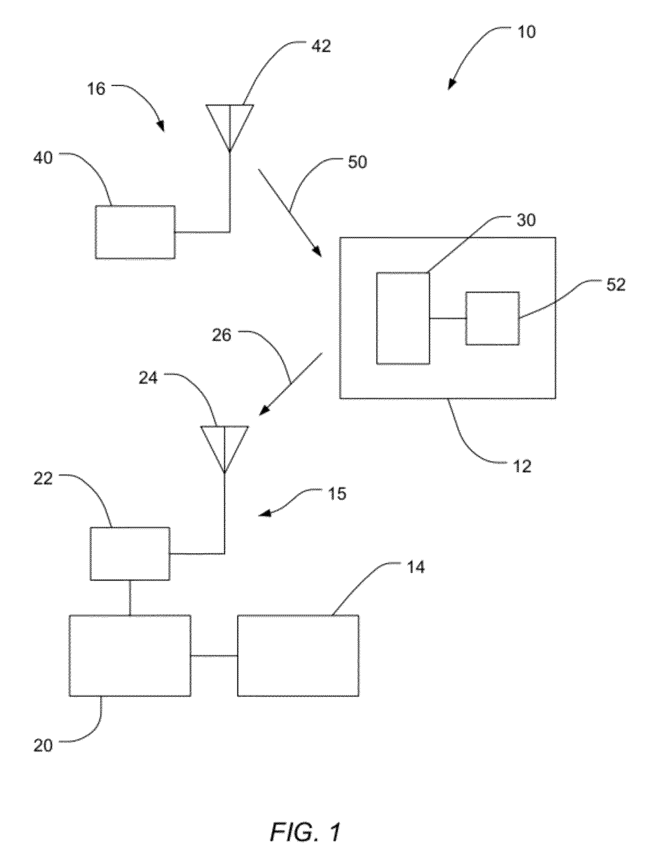

FIG. 1 is a block diagram of a clock control system 10 according to some embodiments of the invention. Among other things, the clock control system 10 provides improved capability for keeping track of the time that remains in a game or in a certain period of a game, such as a sporting event. The control system 10 includes a timer or clock 14 that is wirelessly coupled to a portable signaling device 12. The terms “timer” and “clock” are used interchangeably herein. The clock 14 is coupled to (or alternatively incorporates) a receiver system 15 and control circuit 20 that allows it to receive wireless transmissions 26 from the portable signaling device 12. In some embodiments the control system 10 also includes one or more transmitter systems 16 that transmit a signal 50 that energizes the portable signaling device 12, enabling the portable device 12 to send the wireless transmissions 26 to the receiver system 15, the control circuit 20, and the clock 14.

The portable signaling device 12 allows a person, such as an official, referee, or other person to remotely control the clock 14 through one or more wireless transmissions 26. For example, an official may actuate the signaling device 12 to stop the clock 14 when there is a break in the sporting event. In some embodiments an official may use the portable device 12 to direct participants in the sporting event, while simultaneously sending wireless commands to the clock 14. In addition to sending wireless transmissions to the game clock 14, for example, the portable device 12 may also emit an audible signal. In some embodiments the portable signaling device 12 comprises a whistle having wireless transmitting capability.

Referring again to FIG. 1, in some embodiments the receiver system 15 comprises a receiver 22 and a receiving antenna 24. The receiver system 15 is coupled to or incorporates the control circuit 20 coupled to the game clock 14 to automatically control operation of the game clock 14 according to wireless transmissions received from the portable signaling device 12. In operation, the antenna 24 picks up the wireless (e.g., electromagnetic) signal 26 from the portable device 12 and the receiver 22 processes the signal and relays relevant information from the signal 26 to the control circuit 20. The control circuit 20 then operates the game clock 14 according to the wireless signal 26.

In some embodiments of the invention, the control system 10 includes a stationary transmitter system 16 that comprises a stationary transmitter 40 coupled with a transmitting antenna 42. According to some embodiments, the stationary transmitter 40 and the antenna 42 transmit a signal 50 that energizes the portable signaling device 12, allowing it to transmit the wireless signal 26 to the receiver system 15 and the clock 14. For example, in some embodiments the portable signaling device 12 incorporates a passive and normally unpowered transmitter. When energized by the energy signal 50, the portable signaling device 12 can transmit the wireless signal 26 to the receiver system 15, providing control of the timer 14 without the need for batteries or other power sources in the portable device 12. In some embodiments the receiver system 15 and/or the transmitter system 16 are stationary components of the control system 10, while the portable device 12 may be moved about the sporting event area by an official monitoring the event.

As shown in FIG. 1, in some embodiments the portable signaling device 12 includes a transmitter 30 that allows the portable device 12 to transmit wireless control signals 26 to the stationary receiver 22 and control circuit 20. For example, the portable device 12 may transmit one or more distinct clock signals that control the event clock 14. In some embodiments the transmitter 30 may be integrated with or coupled to an antenna to enhance transmission of the clock signal.

According to some embodiments, the portable device 12 also includes an actuator or switch 52 coupled to the transmitter 30. The actuator 52 is adapted to enable and/or disable the transmitter 30, thus allowing or preventing the transmitter 30 from transmitting the wireless signal 26 to the stationary receiver 22. For example, in some cases the transmitter 30 is normally disabled, with the actuator 52 in an off position. In the disabled state the transmitter 30 will not transmit the wireless signal 26 to the stationary receiver whether or not the transmitter 30 is energized by the stationary transmitter's signal 50. When an official carrying the portable signaling device 12 desires to remotely operate the clock 14, the official can actuate the switch 52 in order to enable transmission by the transmitter 30. In the case that the transmitter 30 is a passive, normally unpowered transmitter, the signal 50 from the stationary transmitter 40 energizes the transmitter, causing it to transmit the wireless signal 26 in a powered and enabled state.

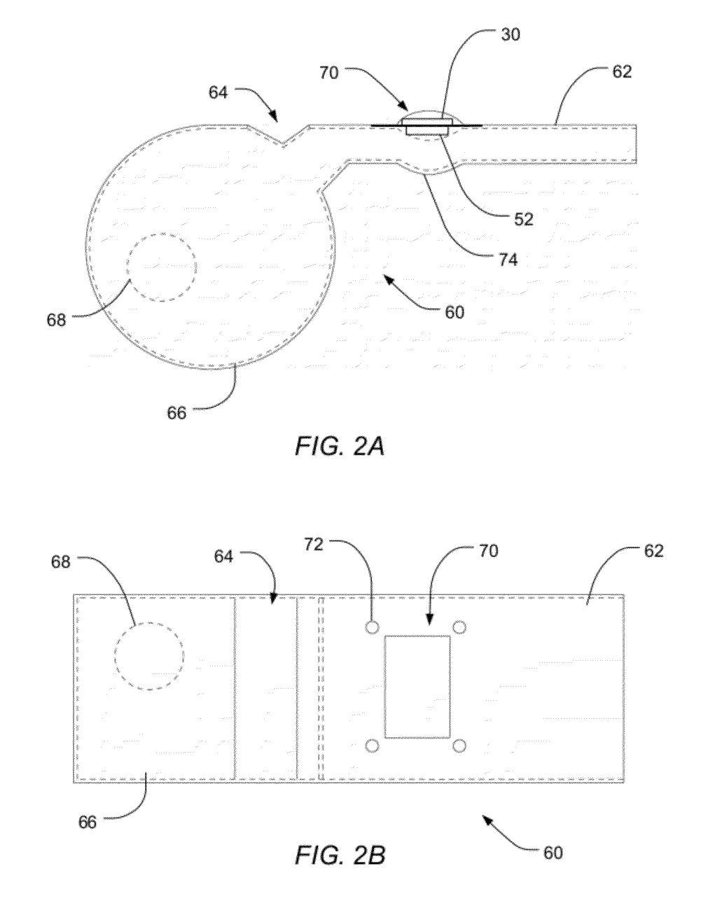

According to some embodiments of the invention, the portable signaling device 12 is relatively small and configured to be easily carried (e.g., in the hand, hanging around a neck, inside a pocket) by an official during a sporting event. Turning to FIGS. 2A and 2B, in some preferred embodiments the portable signaling device 12 comprises a whistle 60, similar in many respects to those ordinarily used by officials and referees at many types of sporting events. In addition to emitting an audible signal used by an official to direct a sporting event, the whistle 60 is capable of sending wireless transmissions 26 to the game clock 14 in order to control operation of the clock 14.

The whistle 60 includes a mouthpiece 62, an air slot 64, and a resonant chamber 66, optionally including a pea 68. A transmitting module 70 is mounted on the mouthpiece 62 with fasteners 72 (e.g., screws). FIG. 2A shows a schematic representation of the transmitting module 70, which incorporates a passive transmitter 30 coupled with an air-activated actuator 52. It should be appreciated that there are a wide variety of ways of coupling together and packaging a transmitter and air-activated switch depending upon, e.g., the types of switches and transmitters, and the physical limitations of the whistle 60. The actuator or switch 52 may be activated in a variety of manners depending upon the particular implementation. For example, in some embodiments incorporating the whistle 60, the actuator 52 is an air-activated switch (e.g., a pressure-sensitive, vibrations, or mechanical switch) located at least partially within the air flow path of the whistle 60. When an official blows the whistle to signal a stoppage in play, the air flow through the whistle toggles the actuator 52 on or off. In some cases the actuator 52 is normally off, such that the transmitter is normally disabled. When an official blows the whistle, the air flow activates the switch 52, thus enabling the transmitter 30 to transmit the wireless signal 26 to the stationary receiver 22. After the official stops blowing the whistle, the actuator 52 again moves to the off position and the transmitter 30 is disabled. In some cases the mouthpiece 62 may include a contoured portion 74 underneath the transmitting module 70 to provide extra airflow capacity around the actuator 52.

In some embodiments the whistle 60 is made of plastic or a metal or metal alloy such as steel. The transmitter 30 may be positioned on or within the whistle 60 in any suitable manner, including entirely within the whistle 60 or attached to the outside of the whistle 60. In some embodiments the transmitter 30 is a passive (normally unpowered) and relatively small transmitter (e.g., when compared to the size of the stationary transmitter system 16) that is energized by the stationary transmitter system 16, and thus does not require batteries or another power source. Such aspects of the invention provide a compact, light weight, and easy-to-use portable signaling device without the need for exterior wires, transmitters, or other circuitry located elsewhere on the official using the whistle 60.

The transmitter 30 may be implemented using a number of technologies. In some embodiments the transmitter 30 communicates with the receiver system 15 via an active communication protocol, such as Bluetooth. In some embodiments, the transmitter 30 is a passive and normally unpowered transmitter that generates the wireless transmissions 26 to the receiver system 15 when it is energized by the energy signal 50 generated by the stationary transmitter system 16. For example, a passive transmitter 30 may be similar to a passive security tag used to prevent shoplifting in retail stores. In some embodiments, the transmitter 30 comprises an acousto-magnetic tag. When enabled by the actuator 52 in the presence of the energy signal 50, the acousto-magnetic tag emits the wireless signal 26, thus providing remote control of the clock 14. In some embodiments, the transmitter 30 comprises a radio frequency identification (RFID) tag.

According to some embodiments, the wireless signal 26 sent from the transmitter 30 to the stationary receiver system 15 may comprise a wide variety of information. As just two examples, the wireless signal may indicate a clock signal such as a stop clock signal or a start clock signal. Upon receiving the clock signal, the stationary receiver 22 processes the wireless signal and relays the clock signal to the control circuit 20, which operates the clock 14. In some cases the transmitter 30 may only transmit one signal and the receiver and/or control circuit interprets the signal as one of two or more types of signals. For example, receiving a clock signal when the clock 14 is running may cause it to stop, while receiving a clock signal when the clock 14 is stopped may cause it to start. In some embodiments the time of the command signal 26 is logged but no action is taken with respect to the clock 14. In such cases the control system 10 can determine when a portable signal device is activated (e.g., a whistle is blown) without affecting operation of the clock, which may be useful for sporting events, such as soccer, in which the clock does not stop during play.

Depending upon the particular embodiment, the transmitter 30 may be configured to generate and emit the control signal 26 as either an analog signal or a digital signal. In some cases the mere transmission and subsequent detection of the signal 26 provides control of the clock 14. However, the control signal 26 may include further information encoded in, e.g., the amplitude and/or frequency of an analog signal, or the bit pattern of a digital signal. For example, in cases where multiple whistles 60 are used (e.g., by multiple officials), the transmitter 30 of each whistle may emit a specific digital signal corresponding to a unique serial number assigned to the whistle. In some embodiments upon receiving a particular signal, the receiver system 15 can thus identify which whistle generated the transmission 26. For example, in some cases each whistle may include a transmitter 30 that is a RFID tag, each having a unique serial number that it transmits when activated.

The control circuit 20 may log this information or in some cases use a whistle serial number or other signal characteristics of the transmission 26 (e.g., frequency, amplitude, etc.) in an authentication protocol. For example, the control circuit 20 may be programmed to recognize and respond to a defined set of whistle serial numbers, while ignoring command signals that do not include an authorized serial number. Thus, the control system 10 in such an embodiment can advantageously ignore signals from unauthorized devices, which can help limit clock tampering by fans, players, and other unauthorized parties.

As previously discussed, in some embodiments the portable signaling device 12 includes a passive or unpowered transmitter that transmits a clock signal when it is energized and optionally enabled. According to some embodiments, one or more stationary transmitter systems 16 may be positioned about the area of the sporting event to provide sufficient coverage and ensure that one or more portable devices 12 being moved around the sporting event area will be adequately energized regardless of its location in the event area. The number of stationary transmitters and their locations can vary depending upon the size and configuration of the particular sporting event area, and also the power and range of each individual stationary transmitter.

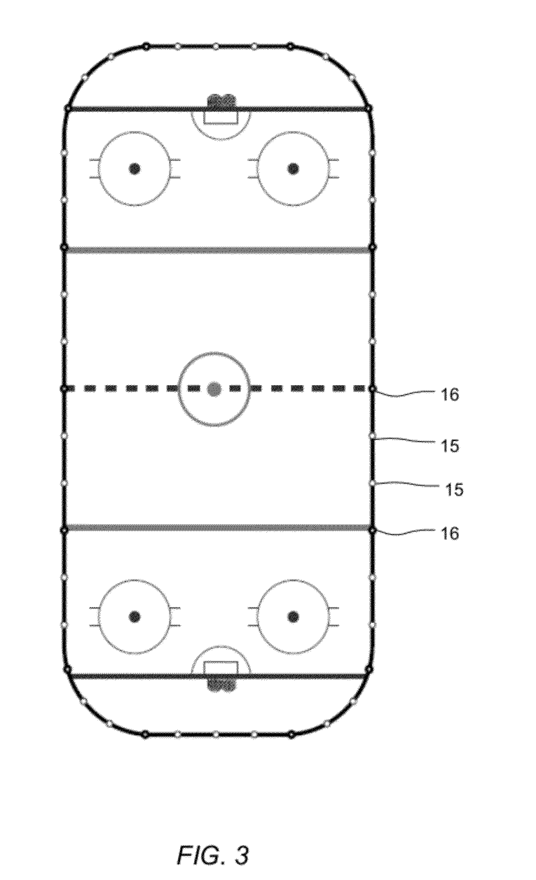

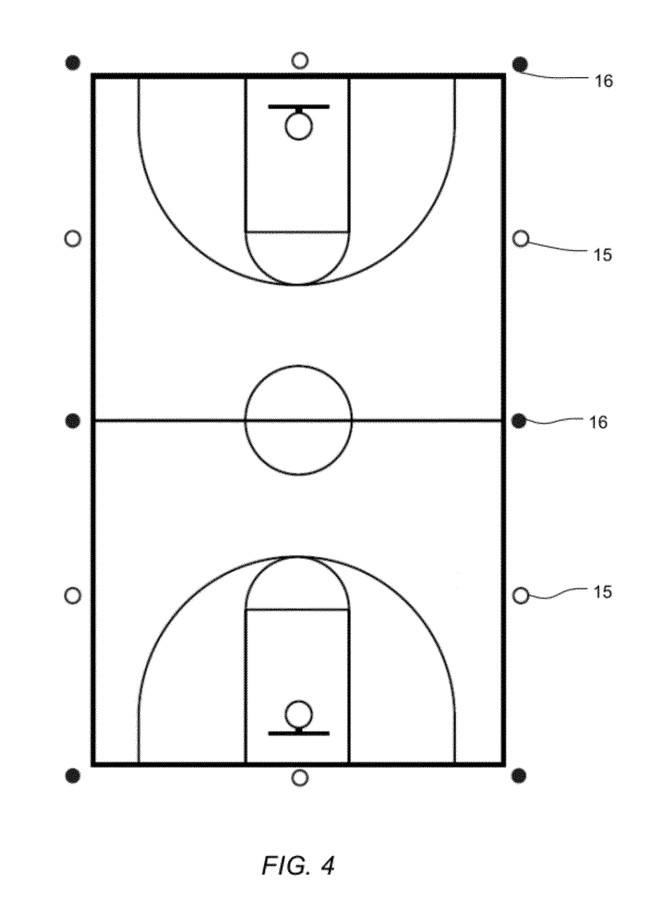

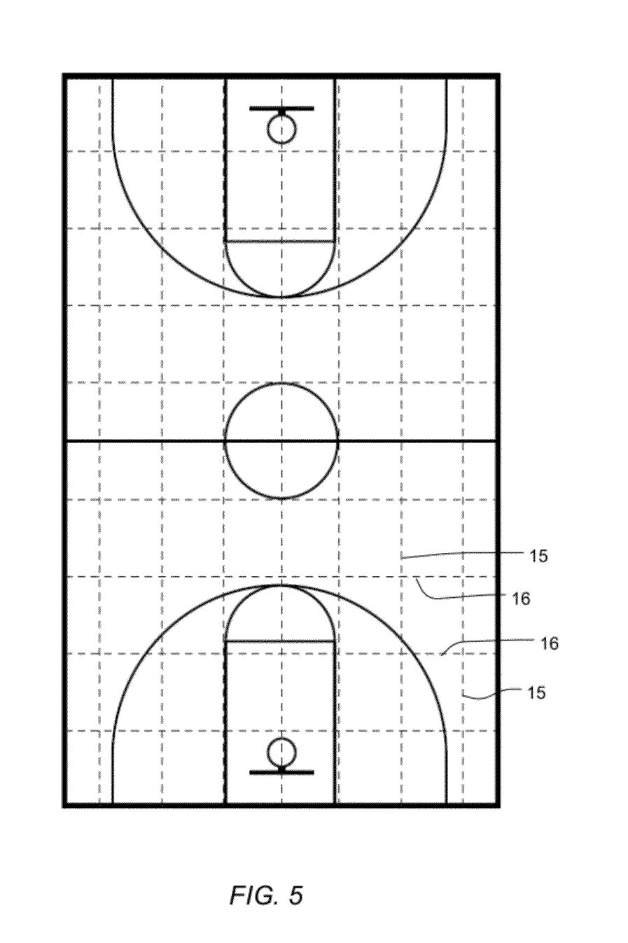

FIGS. 3-5 illustrate a variety of possible arrangements of multiple stationary transmitter and receiver systems 16, 15. The spacing and the number of transmitter and receiver systems 16, may vary depending upon the size of the event area and the power of the transmitters, receivers and portable signaling devices. As shown in FIGS. 3 and 4, multiple transmitter systems 16 and receiver systems 15 can be positioned about a hockey rink and a basketball court. Such transmitter and receiver systems may be mounted about the area in any suitable manner. For example, they may be attached to or suspending from a ceiling or attached to other structure about the area. As such, they may be installed at existing sporting facilities with relative ease. Turning to FIG. 5, in some cases the transmitter and/or receiver systems may be embedded in or under the playing surface of the sporting event area during installation or renovation of the playing surface, such as under the floorboards of a basketball court. Conversely, the transmitter and/or receiver systems can also be suspended from a ceiling above the playing area.

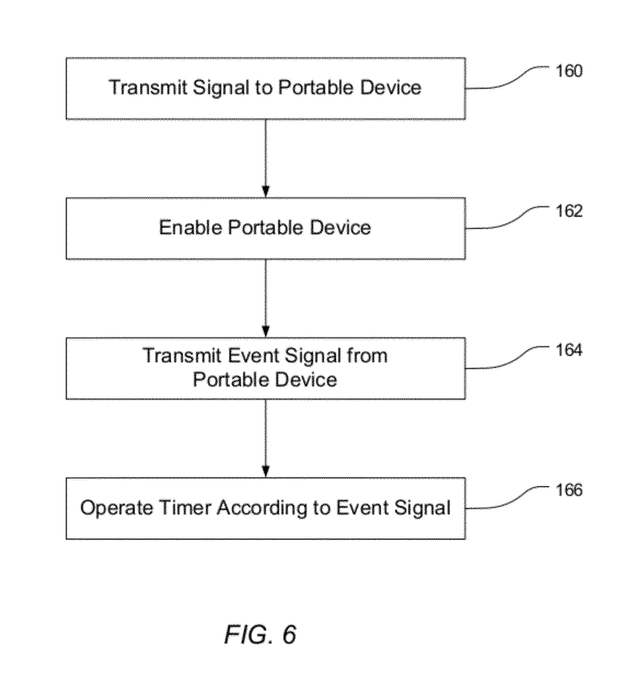

FIG. 6 is a flowchart illustrating a method of remotely controlling a clock, such as the game clock 14 illustrated in FIG. 1. A stationary transmitter is used to transmit a signal, such as a power signal, to one or more portable signaling devices (160). The transmitted signal may be a continuous signal, pulsed, or otherwise intermittent and is preferably configured to energize the one or more portable devices. For example, one or more portable signaling devices can include a passive or unpowered transmitter, which is energized when the portable device receives the signal from the stationary transmitter.

The method also includes enabling the portable signaling device (162). For example, an operator, such as an official, may actuate the portable signaling device in order to enable transmission by the passive transmitter. Actuating the device can include toggling a switch or other actuator. In some cases the portable signaling device is a whistle and the passive transmitter is actuated by the official blowing air through the whistle to activate an air-sensitive actuator.

Once energized and enabled, the passive transmitter transmits a clock signal from the portable signaling device (164), which is received by a stationary receiver system. The stationary receiver system is coupled to an event timer such as a game clock, and operation of the event timer is controlled according to the clock signal (166). In some cases a separate control circuit couples the receiver and game timer in order to provide control of the game timer.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A control system for a game clock, comprising:
a stationary transmitter adapted to transmit a first signal;
a portable signaling device for transmitting a clock signal, the portable signaling device having a passive transmitter coupled to an actuator adapted to enable and disable transmission by the passive transmitter, the passive transmitter adapted to transmit the clock signal when enabled by the actuator and energized by the first signal from the stationary transmitter;
a stationary receiver adapted to receive the clock signal from the portable signaling device; and
a control circuit coupled to the stationary receiver, the control circuit adapted to be coupled to a game clock, receive the clock signal and operate the game clock according to the clock signal.

2. The system of claim 1, further comprising a stationary transceiver comprising the stationary transmitter and the stationary receiver.

3. The system of claim 1, further comprising a plurality of stationary transmitters.

4. The system of claim 1, wherein the clock signal is a stop clock signal.

5. The system of claim 1, wherein the clock signal is a start clock signal.

6. The system of claim 1, wherein the actuator is an air-activated switch.

7. The system of claim 1, wherein the portable signaling device comprises a whistle.

8. A control system for controlling a game clock, comprising:
a stationary transmitter adapted to transmit a first signal;
a hand-held whistle for transmitting a clock signal, the whistle comprising a passive transmitter coupled to an air-activated switch adapted to enable and disable transmission by the passive transmitter, the passive transmitter adapted to transmit the clock signal when enabled by the air-activated switch and energized by the first signal transmitted by the stationary transmitter;
a stationary receiver adapted to receive the clock signal from the whistle; and
a control circuit coupled to the stationary receiver, the control circuit adapted to be coupled to a game clock, receive the clock signal and operate the game clock according to the clock signal.

9. The system of claim 8, wherein the clock signal is a stop clock signal.

10. The system of claim 8, wherein the clock signal is a start clock signal.

11. The system of claim 8, further comprising a stationary transceiver comprising the stationary transmitter and the stationary receiver.

12. The system of claim 8, further comprising a plurality of stationary transmitters.

13. A method of remotely controlling a game clock, comprising:
transmitting a signal from a stationary transmitter;
receiving the signal with a portable signaling device having a passive transmitter;
actuating the portable signaling device to enable transmission by the passive transmitter;
transmitting a clock signal from the portable signaling device;
receiving the clock signal with a stationary receiver; and
controlling operation of a game clock according to the clock signal.

14. The method of claim 13, wherein actuating the portable signaling device generates an audible signal.

15. The method of claim 14, wherein the portable signaling device comprises a whistle.

16. The method of claim 13, wherein the clock signal comprises a stop clock signal.

17. The method of claim 13, wherein the clock signal comprises a start clock signal.
